(19) United States
(12) Patent Application Publication
(10) Pub. No.: US 2010/0318319 A1
(43) Pub. Date: Dec. 16, 2010

(54) PROJECTION APPARATUS

(76) Inventor: Konrad MAIERHOFER, Traunreut (DE)

Correspondence Address: KATTEN MUCHIN ROSENMAN LLP, 575 MADISON AVENUE, NEW YORK, NY, 10022-2585, US

(21) Appl. No.: 12/797,974

(22) Filed: Jun. 10, 2010

(30) Foreign Application Priority Data
Jun. 12, 2009 (DE) 102009025201.0-55

(51) Int. Cl. G06F 15/00; G01B 11/00

(52) U.S. Cl. 702/150

(57) ABSTRACT

The invention relates to an apparatus (1) for projection of a specified pattern (17) onto an installation surface (15) whose geometry is previously known, which comprises a laser projector (2) for projection of the pattern (17) onto the installation surface (15), a separate laser distance measurement device (3) based on the principle of the running time measurement of a diffusely reflected laser beam (6), which is connected with the laser projector (2), in a fixed position, whereby the exit direction of the laser beam (6) that leaves the laser distance measurement device (3) is specified in fixed and non-adjustable manner, a drive unit by means of which the laser projector (2) and the laser distance measurement device (3) can jointly be pivoted or rotated about two different axes (N, M), into an angle position that can be specifically specified, and at least one data processing device for controlling the laser projector (2), the laser distance measurement device (3), and the drive unit, in which the laser distance measurement device (3) and the data processing device are set up to calculate the relative orientation and position between laser distance measurement device (3) and installation surface (15), by measuring the distance and the direction of the laser beam (6) emitted by the laser distance measurement device (3) to a plurality of measurement points (P₁, P₂, P₃, P₄, P₅) to be suitably selected on the installation surface (15).

The invention relates to an apparatus and a method for projection of a specified pattern onto an installation surface whose geometry is previously known.

Such apparatuses and methods are sufficiently known from the state of the art, and are used in industrial production processes, such as in aircraft or ship construction, for example, where different components must be installed with great precision on an installation surface formed by the aircraft hull or ship hull, for example. The pattern, which is projected onto the installation surface, which extends in two or three dimensions, serves for visual marking of those points or areas on the installation surface on which one or more components are supposed to be mounted—mostly manually. The geometry of the installation surface is previously known and advantageously is already present in computer-readable form (for example in the form of CAD data).

For projection of the pattern onto the installation surface, the apparatuses of the type mentioned above that are previously known from WO 2006/078684 A2, U.S. Pat. No. 6,547,397 B1, or U.S. Pat. No. 7,306,339 B2, for example, comprise a laser projector that can be controlled by means of a data processing device, which projector in turn has a laser source and two mirrors that are suitably disposed in the beam path of the laser beam and can be pivoted about different axes by means of a galvanometer, in each instance.

In order to meet the precision requirements, which are generally particularly great within the scope of projection of the patterns specified for different assembly steps first as precise a determination as possible of the relative orientation and position of the laser projector with regard to the installation surface is required, after the apparatus has been set up at its location of use.

In the state of the art, this determination mostly takes place using a plurality of retroreflectors, which must be installed precisely at specified reference points of the installation surface. The laser beam of the laser projector is oriented as precisely as possible with regard to the various retroreflectors—with evaluation of the light signal reflected back at the retroreflectors—one after the other, whereby the direction vector of the laser beam is determined for each retroreflector. This vector can be determined from the known setting signals of the galvanometers, for example, or from the settings of the galvanometers determined by means of suitable sensors. Subsequently, the relative position and orientation of the laser projector with regard to the installation surface can be determined by means of evaluation of these direction vectors and the known positions of the retroreflectors in question—using simple and known computing algorithms.

However, this method is disadvantageous in multiple respects. For one thing, in this connection, sufficient precision can only be achieved with evaluation of the direction vectors of a large number of different reference points, and for this reason, in practice, when using this method, the direction vectors of at least six different reference points whose location is precisely known are evaluated. For another thing, the installation of a plurality of retroreflectors, which is necessary, proves to be time-consuming and labor-intensive, particularly if six or more retroreflectors are used in order to achieve sufficient precision.

In this connection, the use of a laser projector is furthermore known from U.S. Pat. No. 6,547,397 B1, in which not only the direction of the laser beam emitted by the laser projector but also the distance to a (cooperative) “target” that reflects the laser beam on the installation surface can be determined, whereby the distance measurement is based on a running time measurement of the laser beam. This, too, is disadvantageous because of the use of targets that must be separately applied to the installation surface, which use continues to be necessary.

And finally, a projection apparatus is known from U.S. Pat. No. 7,306,339 B2, in which the diffuse reflection of the laser beam emitted by the laser projector onto the installation surface is evaluated in order to generate a more or less detail-rich image of the installation surface.

Furthermore, in the case of projection apparatuses of the aforementioned type, recalibration of the laser projector is also required from time to time, since various drift effects—which result in undesirable offset—have a detrimental effect on the direction of the emitted laser beam. On a longer time scale, such drift is caused by aging effects. On shorter time scales, temperature variations and/or mechanical influences on the apparatus or its components, in particular, can cause a corresponding deviation. This set of problems particularly relates to control of the galvanometers by means of which the two mirrors of the laser projector that deflect the laser beam are set, so that the aforementioned effects in the state of the art discussed above also have a disadvantageous effect on the determination of the relative position and orientation of the laser projector with regard to the installation surface.

In order to eliminate the undesirable offset, in the previously known state of the art, a time-consuming and labor-intensive evaluation of the reflection of the laser beam at a plurality of previously known reference points (particularly at retroreflectors or cooperative targets that must be separately installed) on the installation surface must take place, and this is complicated.

Finally, as an introduction, it should also be noted that the present invention particularly relates to such laser projection systems that are set up within an aircraft hull or in the region of some other type of large-format installation surface, for example, in which the (maximal) projection range of the laser projector does not cover the entire installation surface. In this connection, projection range is understood to mean the (angle) range in which a laser beam can be emitted; in the state of the art, it typically corresponds to an angle range of approximately ±30°, in the horizontal and vertical direction, in each instance. For such tasks, it is already known from the state of the art to configure the projection apparatus in such a manner that a laser projector can be pivoted about a spatial axis by a drive unit, in order to cover a larger installation surface, but this makes it necessary to make available and install a plurality of retroreflectors distributed over the entire installation surface, so that the laser projector can sufficiently “orient” itself relative to the installation surface in every setting of the drive unit.

Against the background of the state of the art as explained above, it is the task of the present invention to make available a projection apparatus (and a method) of the type stated initially, which is as advantageous and precise as possible, and can be installed and calibrated in as simple a manner as possible, using apparatus components that are structured as simply as possible.

This task is accomplished with an apparatus for projection of a specified pattern onto an installation surface whose geometry is previously known, according to claim 1.

For this purpose, the apparatus according to the invention comprises a laser projector for projection of the pattern onto the installation surface, a separate laser distance measurement device based on the principle of the running time measurement of a diffusely reflected laser beam, which is connected with the laser projector, in a fixed position, whereby the exit direction of the laser beam that leaves the laser distance measurement device is specified in fixed and non-adjustable manner, a drive unit by means of which the laser projector and the laser distance measurement device can jointly be pivoted or rotated about two different axes (preferably oriented perpendicular to one another), into an angle position that can be specifically specified, and at least one data processing device for controlling the laser projector, the laser distance measurement device, and the drive unit. Furthermore, according to the invention, it is provided that the laser distance measurement device and the data processing device are set up to calculate the relative orientation and position between laser distance measurement device and installation surface, by measuring the distance and the direction of the laser beam emitted by the laser distance measurement device to a plurality of measurement points to be suitably selected on the installation surface. In this connection, it should be noted that the relative spatial position (=position and orientation) between laser distance measurement device and installation surface, as well as that between laser projector and installation surface, is always dependent on the current setting of the drive unit, but this does not represent any major problems from a mathematical point of view.

It first of all proves to be of advantageous significance within the scope of the present invention that the relative spatial position of the laser projector with regard to the installation surface is not determined, according to the invention, by way of an evaluation of a light signal deflected by adjustable optics of the laser projector. Instead, within the scope of the present invention, the laser distance measurement device—which advantageously does not have any moving positioning elements—is exclusively used in the determination of the relative spatial position, and from its spatial position, the relative spatial position of the laser projector can also be determined—because of the positionally fixed connection of laser distance measurement device and laser projector.

The calculation of the relative spatial position of the laser distance measurement device with regard to the installation surface is based on the distances and directions to be measured (manually or automatically), to a plurality of measurement points on the installation surface—which can fundamentally be freely selected. Since the laser beam leaves the laser distance measurement device in a fixed, specified exit direction, the various measurement points on the installation surface have to be approached by means of pivoting of the laser distance measurement device (along with the laser projector), which pivoting can be precisely controlled by means of the drive unit. However, since the measurement points can be freely selected (and their position does not have to be previously known), no great effort is connected with the selection of the points. The direction of the laser beam emitted by the laser distance measurement device results from the setting of the drive unit in the two axes of rotation and pivoting (and the arrangement and geometry of the laser distance measurement device known for this purpose), which can be determined by means of suitable sensors, for example (for example angle decoders), in precise manner. An angle resolution of at least 50,000 or even at least 100,000 increments per revolution should be aimed at.

The measurement points measured in this manner can then be placed into a (virtual) coordinate system for the further calculation steps, and—using known computing algorithms—can be coordinated with the known geometry of the installation surface and brought into agreement with it, for example by means of a so-called “best fit” of the known installation surface geometry into the measured measurement points. It is evident that in this connection, the precision that can be achieved is increased with the number of suitably selected measurement points. Since the spatial position of the laser distance measurement device within the coordinate system is also known or can be determined, its relative position with regard to the installation surface can then be determined (as a function of the drive unit setting). From this, the relative position of the laser projector is also obtained, which is also relevant for the projection of the specified pattern onto the installation surface.

In other words, within the scope of the present invention, a simple and comparatively cost-advantageous laser distance measurement device can be used, whose laser beam always exits from it in the identical direction, and is not deflected by way of movable (and drift-prone) mirrors. The drive unit provided according to the invention therefore serves primarily for adjustment of the spatial direction of the laser beam emitted by the laser distance measurement device (in that the entire laser distance measurement device is rotated or pivoted about two axes, into the desired direction). In a second aspect, the drive unit according to the invention allows the projection of suitable patterns onto large-format installation surfaces, as was already mentioned in the introduction. In this connection, it is furthermore particularly advantageous that the laser projector does not have to be recalibrated or calibrated in terms of its relative spatial position with regard to the installation surface, even after its rotation or pivoting.

Furthermore, within the scope of the present invention, it is not necessary to make use of an installation of retroreflectors or of other cooperative (i.e. well-reflecting) targets on the installation surface in order to determine the relative spatial position of the laser distance measurement device and/or of the laser projector with regard to the installation surface. The distance measurement carried out according to the invention, on the basis of a laser beam that is only reflected diffusely, permits the selection of any desired measurement points on the installation surface.

In a preferred embodiment of the present invention, it is provided that the laser projector and the laser distance measurement device are disposed (in a fixed position) within a common housing of the apparatus. In this way, the drive unit provided according to the invention can be built onto the (common) housing, and this proves to be particularly practical for the purpose.

Furthermore, within the scope of another practical further development of the present invention, it is preferably provided that the apparatus comprises a target that has a retroreflector, and is set up, for the purpose of calibration of the laser projector, to carry out the following steps:
i) Positioning of the target, which has a retroreflector, at any desired location within the projection range of the laser projector, and determination of the position of the target and of the retroreflector relative to the laser distance measurement device,
ii) Automatic orientation of the laser beam of the laser projector onto the retroreflector and determination of the direction vector of the laser beam with reference to the laser projector,
iii) Consecutive multiple changes in the setting of the drive unit, whereby the laser beam of the laser projector is re-oriented onto the retroreflector, which has been left in place, in every setting of the drive unit, and subsequently the direction vector of the laser beam with reference to the laser projector is determined,
iv) Calibration of the control signals for the laser projector that are required for projection of a laser beam onto the installation surface, by means of evaluation of the data determined in Steps ii) and iii).

In the set-up of the apparatus according to the invention as indicated above, for the purpose of calibration of the laser projector, it is advantageous that first of all, only one retroreflector needs to be used, which second of all can be positioned essentially as desired, and that third of all, Steps iii) and iv), in particular, can also be carried out fully automatically, so that the time expenditure for calibration of the laser projector that is required in the state of the art can be clearly reduced. Thus, a disadvantageous drift or an undesirable offset in the control of the galvanometers of the laser projector that carry the mirrors can be effectively counteracted—by means of the use of simple computing algorithms—within the scope of the calibration steps that influence the subsequent pattern projection. Great precision of the projection apparatus according to the invention is the direct result of its advantageous configuration.

The present invention furthermore also relates to a method for projection of a specified pattern onto an installation surface whose geometry is previously known, using an apparatus as explained above, which comprises the following steps:
A) Set-up of the apparatus in the area of the installation surface,
B) Consecutively performed orientation of the laser beam of the laser distance measurement device at different measurement points of the installation surface, to be suitably selected, in that the laser distance measurement device is pivoted or rotated, by means of the drive unit, in such a manner until the laser beam hits the measurement point, in each instance, and determination of the setting of the drive unit, in each instance, as well as of the distance of the measurement point from the laser distance measurement device,
C) Calculation of the position and orientation (independent of the drive unit setting) of the laser distance measurement device relative to the installation surface, from the data obtained in Step B),
D) Projection of the pattern onto the installation surface by means of the laser projector.

Since this method is based on the same aspects as the apparatus that has already been described, reference can be made to the above explanations in connection with the projection apparatus according to the invention, with regard to the advantages of the method according to the invention. All the aspects mentioned there apply in the same manner for the method according to the invention.

Furthermore, in a further development of the method according to the invention, it is provided that at least before the first projection of a pattern onto the installation surface, for the purpose of calibration of the laser projector, the following steps are carried out:
E) Positioning of a target, which has a retroreflector, at any desired location within the projection range of the laser projector, and determination of the position of the target and of the retroreflector relative to the laser distance measurement device,
F) Automatic orientation of the laser beam of the laser projector onto the retroreflector and determination of the direction vector of the laser beam with reference to the laser projector,
G) Consecutive multiple changes in the setting of the drive unit, whereby the laser beam of the laser projector is re-oriented onto the retroreflector, which has been left in place, in every setting of the drive unit, and subsequently the direction vector of the laser beam with reference to the laser projector is determined,
H) Calibration of the control signals for the laser projector that are required for projection of a laser beam onto the installation surface, by means of evaluation of the data determined in Steps F) and G).

In this connection, it proves to be particularly advantageous that within the scope of the calibration of the laser projector, only one retroreflector, in total, has to be used, and that even this retroreflector does not necessarily have to be installed on the installation surface. As an alternative to the calibration method for the laser projector indicated above, however, it would also be possible to use a variant that uses a plurality of retroreflectors, but this is not as advantageous.

In another preferred further development of the method according to the invention, the determination of the position of the target relative to the laser distance measurement device that is required in Step E) can, once again, take place exclusively using the laser distance measurement device. In the case of a target whose geometry is known, the relative position of the target with regard to the laser distance measurement device (from which that with regard to the laser projector is also obtained) can be calculated by means of measuring multiple measurement points on the target (for example using a “best fit” algorithm). Since the position of the retroreflector on the target is also previously known and thus can be calculated precisely, in terms of its spatial position, here again, a method for precise calibration of the laser projector is made available, which avoids errors to a particular degree.

In the following, an exemplary embodiment of the invention will be explained in greater detail using the drawing. In this connection, the drawing shows:

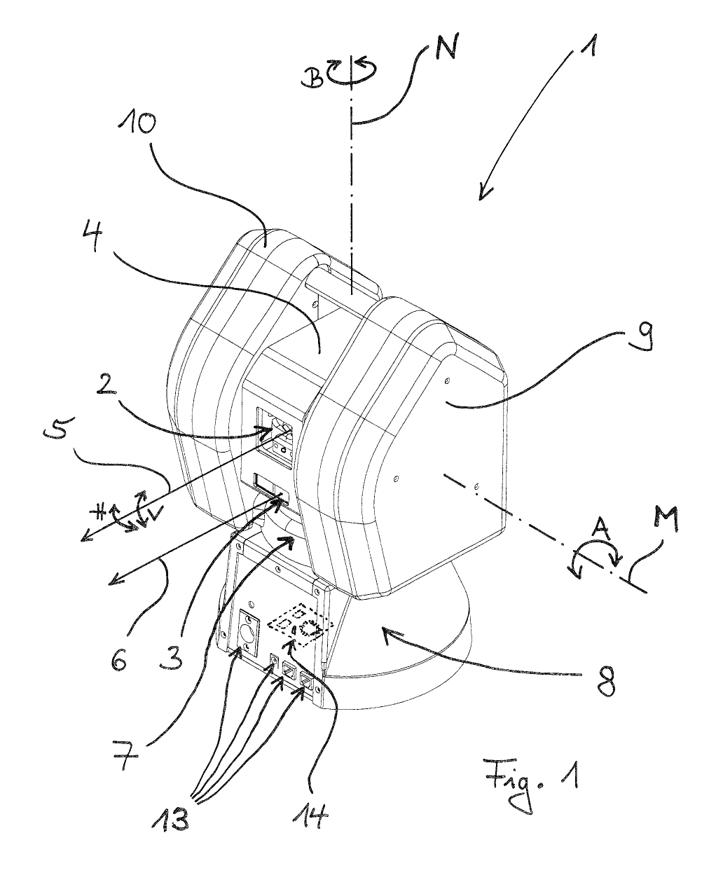

FIG. 1 a perspective representation of an exemplary embodiment of a projection apparatus according to the invention,

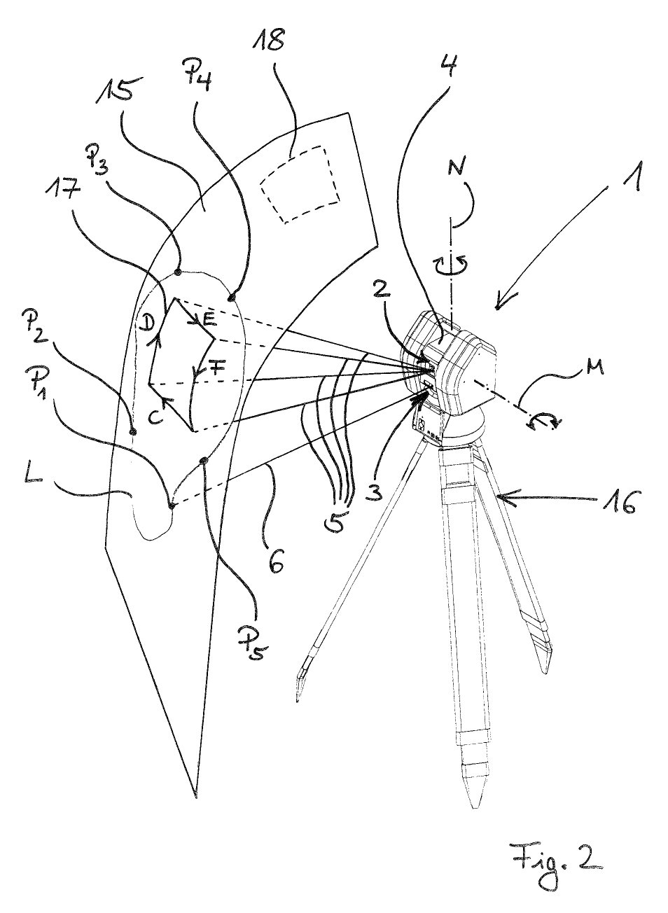

FIG. 2 a perspective representation of the apparatus from FIG. 1, which is set up in front of an installation surface, by means of a tripod,

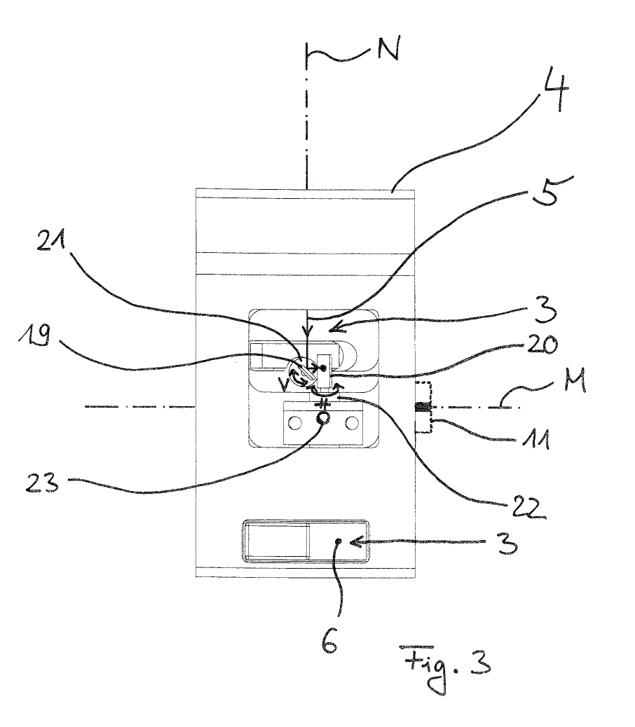

FIG. 3 a front view of the housing of the apparatus from FIG. 1,

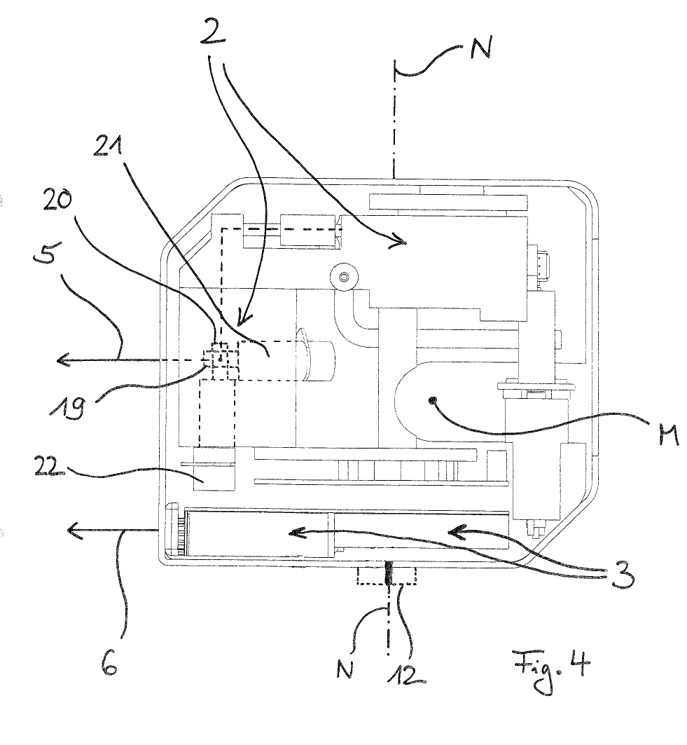

FIG. 4 a side view, in section, through the housing from FIG. 3, and

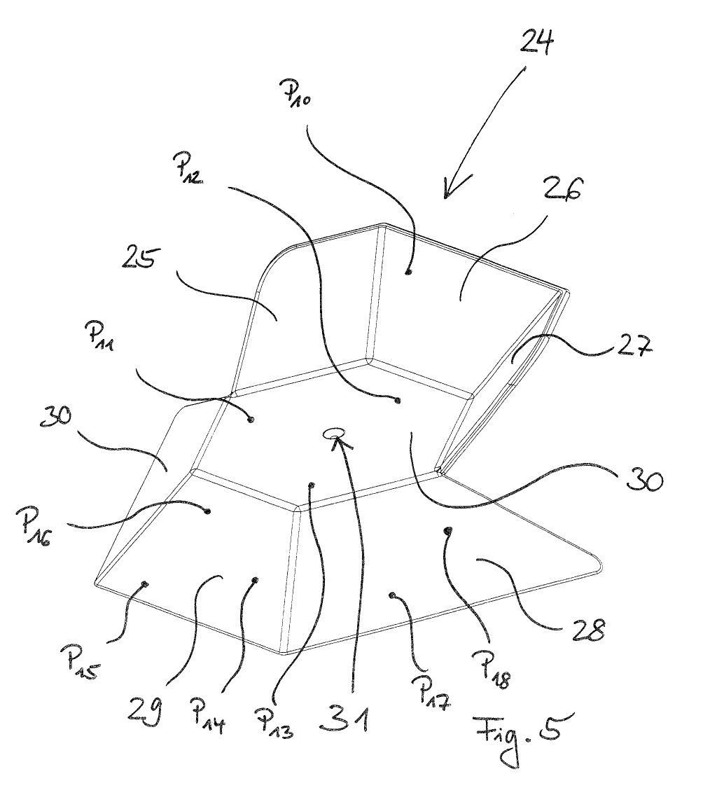

FIG. 5 a target that is suitable for calibration of the laser projector of the apparatus according to the invention.

The laser projection apparatus 1 shown in FIG. 1 comprises a laser projector 2 that emits a first laser beam 5, and a laser distance measurement device 3, separate from it, that emits a second laser beam 6, both of which are accommodated in a common housing 4 of the apparatus 1. By means of the first laser beam 5 emitted by the laser projector 2, a pattern can be projected onto an installation surface—not shown in FIG. 1—in that the laser beam 5 can be pivoted in the horizontal direction according to the double arrow H, and over a specified angle range of preferably approximately ±30°, in each instance, according to the double arrow V. The mirrors connected with galvanometers, which are shown in FIGS. 3 and 4 and explained further below, serve for this purpose. The aforementioned angle range determines the maximal projection range of the laser projector 2 (at a specified setting of the drive unit). The laser distance measurement device 3, just like the laser projector 2, is mounted in a fixed position within the housing 4, so that laser projector 2 and laser distance measurement device 3 are disposed in a fixed position relative to one another. The second laser beam 6, which is emitted by the laser distance measurement device 3, is specified in fixed and non-adjustable manner with regard to its exit direction (out of the laser distance measurement device 3 and thus out of the housing 4), as shown in FIG. 1, and therefore cannot be adjusted without pivoting the laser distance measurement device 3 as a whole.

The apparatus furthermore has a drive unit by means of which the laser projector 2 and the laser distance measurement device 3, together with the housing 4, can be pivoted or rotated jointly about two different axes M and N, according to the double arrows A, B. The drive unit consists of (at least) two highly precisely adjustable positioning motors 11, 12, of which a first (indicated with broken lines in FIG. 4) is disposed in the upper region 7 of the base 8 disposed underneath the housing, for rotation or pivoting of the housing 4 about the axis N, which runs vertically. The rotation or pivoting of the housing 4 about the horizontal axis M takes place by means of a second positioning motor, which is optionally disposed in one of the two housing shells 9, 10 that lie against the housing 4 from different sides. Each positioning motor 11, 12 comprises an angle decoder—not shown—with which the given angle position of the setting of the positioning motor 11, 12, in each instance, can be determined with great precision. Furthermore, multiple (data/electricity) interfaces 13 are provided on the base 8, which are connected with the data processing device 14 that is integrated into the base 8 and only shown with broken lines, so that this device can be connected with an external data processing system.

FIG. 2 once again shows a perspective view of the apparatus 1 already described in connection with FIG. 1, which in the present case is set up in the area of an installation surface 15 that extends in three dimensions, by means of a tripod 16. The laser beam 6 emitted by the laser distance measurement device 3 is imaged on the installation surface 15 in the shape of a point (Point P), while the laser beam 5 emitted by the laser projector 2 is guided over the installation surface 15 along the arrows C, D, E, F, continuously and at a sufficient frequency to generate a standing pattern 17. In the present case, the pattern 17 represents an outline sketch for the precise position of an installation part to be installed on the installation surface 15. The further pattern 18 (shown only with broken lines) lies outside of the maximal projection range of the laser projector 2 at the current setting of the drive unit 11, 12 that specifies the rotation of the housing 4 about the axes N, M, so that the housing 4 of the apparatus 1, after completion of the first installation work step in the region of the first pattern 17, can be pivoted by means of the drive unit 11, 12, to such an extent that the second pattern 18 can be projected onto the installation surface 15 by the laser projector 2.

In order to determine the relative spatial position between laser distance measurement device 3 and installation surface 15, the housing 4 is pivoted by means of the drive unit 11, 12, in such a manner that the laser beam 6 of the laser distance measurement device 2, for example, follows the trajectory L on the installation surface 15. During this movement, a plurality of freely selectable measurement points P1, P2, P3, P4, P5, etc. can be selected and measured with regard to their distance, in each instance, from the laser distance measurement device 3, and the concrete angle position of the two positioning motors 11, 12, from which the direction vector of the laser beam with regard to the point, in each instance, can be calculated. If one now places the measurement points P1, . . . , P5 that have been obtained into a coordinate system, then one can determine the spatial position of the installation surface 15, whose geometry is previously known, relative to the laser distance measurement device 3, within the coordinate system, by means of a “best fit” algorithm, thereby also making it possible—vice versa—to calculate the relative spatial position of the laser distance measurement device 3 with regard to the installation surface 15. Proceeding from this, the relative spatial position of the laser projector 2 with regard to the installation surface 15 can also be calculated, by means of simple coordinate transformation, so that precise projection of the specified pattern 17 onto the region of the installation surface 15 intended for this purpose can be carried out.

FIG. 3 shows a front view of the housing 4, in which the two mirrors 19, 20 can be seen, by means of which the laser beam 5 can be adjusted, using the galvanometers 21, 22 that carry the mirrors 19, 20. The mirror 19, which is shown on the left and can be adjusted according to the double arrow V, serves for adjustment of the laser beam 5 that exits from the laser projector 2, in the vertical direction, while the mirror 20, which is shown on the right and can be adjusted according to the double arrow H, serves for deflection of the laser beam in a horizontal direction. Furthermore, a photodiode 23 can be seen on the front side of the housing 4, which can be used, in known manner, for precise and automatic orientation of the laser beam 5 onto a retroreflector.

FIG. 4 shows an additional side view into the housing 4, from which it can be clearly seen that the laser projector 2 and the laser distance measurement device 3 are configured completely separate from one another, and have their own laser source, in each instance.

FIG. 5, finally, shows the target 24 that is preferably used within the scope of the present invention, which has a plurality of planes 25-30 inclined in different directions, whereby a retroreflector 31 is disposed in the precise center of the plane 30 that runs horizontally, on which the laser beam 5 of the laser projector 2 can automatically be oriented, after a determination of the relative spatial position between target 24 and laser distance measurement device 3 was carried out by means of measurement of a plurality of measurement points (here P10-P18, for example), by means of the laser distance measurement device. This can take place in the same manner as the determination of the relative position with regard to the installation surface, namely by evaluation of a “best fit” of the known target geometry into the measurement points P10-P18. Furthermore, the relative position of the retroreflector 31 with regard to the laser distance measurement device and with regard to the laser projector can then also be calculated from its known position on the target 24.

The target 24 can then be used for (automatic) calibration of the laser projector, in the manner described above, without having to be attached to the installation surface 15 or displaced in some other way.

1. Apparatus for projection of a specified pattern onto an installation surface whose geometry is previously known, comprising
a laser projector for projection of the pattern onto the installation surface,
a separate laser distance measurement device based on the principle of the running time measurement of a diffusely reflected laser beam, which is connected with the laser projector, in a fixed position, whereby the exit direction of the laser beam that leaves the laser distance measurement device is specified in fixed and non-adjustable manner,
a drive unit by means of which the laser projector and the laser distance measurement device can jointly be pivoted or rotated about two different axes, into an angle position that can be specifically specified, and
at least one data processing device for controlling the laser projector, the laser distance measurement device, and the drive unit,
whereby the laser distance measurement device and the data processing device are set up to calculate the relative orientation and position between laser distance measurement device and installation surface, by measuring the distance and the direction of the laser beam emitted by the laser distance measurement device to a plurality of measurement points to be suitably selected on the installation surface.

2. Apparatus according to claim 1,
characterized in that
the laser projector and the laser distance measurement device are disposed within a common housing of the apparatus.

3. Apparatus according to claim 1,
characterized in that the apparatus comprises a target that has a retroreflector, and is set up, for the purpose of calibration of the laser projector, to carry out the following steps:
i) Positioning of the target, which has a retroreflector, at any desired location within the projection range of the laser projector, and determination of the position of the target and of the retroreflector relative to the laser distance measurement device,
ii) Automatic orientation of the laser beam of the laser projector onto the retroreflector and determination of the direction vector of the laser beam with reference to the laser projector,
iii) Consecutive multiple changes in the setting of the drive unit, whereby the laser beam of the laser projector is re-oriented onto the retroreflector, which has been left in place, in every setting of the drive unit, and subsequently the direction vector of the laser beam with reference to the laser projector is determined,
iv) Calibration of the control signals for the laser projector that are required for projection of a laser beam onto the installation surface, by means of evaluation of the data determined in Steps ii) and iii).

4. Method for projection of a specified pattern onto an installation surface whose geometry is previously known, using an apparatus according to claim 1, comprising the following steps:
A) Set-up of the apparatus in the area of the installation surface,
B) Consecutively performed orientation of the laser beam of the laser distance measurement device at different measurement points of the installation surface, to be suitably selected, in that the drive unit is moved accordingly, until the laser beam hits the measurement point, in each instance, and determination of the setting of the drive unit, in each instance, the resulting direction of the laser beam, and of the distance of the measurement point from the laser distance measurement device,
C) Calculation of the position and orientation of the laser distance measurement device relative to the installation surface, from the data obtained in Step B),
D) Projection of the pattern onto the installation surface by means of the laser projector.

5. Method according to claim 4,
characterized in that
at least before the first projection of a pattern onto the installation surface, for the purpose of calibration of the laser projector, the following steps are carried out:
E) Positioning of a target, which has a retroreflector, at any desired location within the projection range of the laser projector, and determination of the position of the target and of the retroreflector relative to the laser distance measurement device,
F) Automatic orientation of the laser beam of the laser projector onto the retroreflector and determination of the direction vector of the laser beam with reference to the laser projector,
G) Consecutive multiple changes in the setting of the drive unit, whereby the laser beam of the laser projector is re-oriented onto the retroreflector, which has been left in place, in every setting of the drive unit, and subsequently the direction vector of the laser beam with reference to the laser projector is determined,
H) Calibration of the control signals for the laser projector that are required for projection of a laser beam onto the installation surface, by means of evaluation of the data determined in Steps F) and G).

6. (canceled)

7. Method according to claim 5,
characterized in that
the determination of the position of the target relative to the laser distance measurement device that is required in Step E) takes place exclusively using the laser distance measurement device.
